(19) United States
(12) Patent Application Publication
(10) Pub. No.: US 2016/0183514 A1
(43) Pub. Date: Jun. 30, 2016

(54) DEVICE AND METHOD FOR DISPERSING UNWANTED FLOCKS AND CONCENTRATIONS OF BIRDS

(71) Applicants: Robert J. DEDERICK, Port Ewen, NY (US); Wayne R. JOHNSON, Ulster Park, NY (US)

(72) Inventors: Robert J. DEDERICK, Port Ewen, NY (US); Wayne R. JOHNSON, Ulster Park, NY (US)

(21) Appl. No.: 14/583,341

(22) Filed: Dec. 26, 2014

(51) Int. Cl. A01M 29/06; B64C 39/02; A01M 29/16

(52) U.S. Cl. CPC A01M 29/06; A01M 29/16; B64C 39/024; B64C 2201/146; B64C 2201/12

(57) ABSTRACT

A device for frightening birds from a location is disclosed. The device uses the shape or outline of a predator attached to a powered flying device to maximize the frightening effect. A method of using the device is also provided.

### FIELD OF THE TECHNOLOGY

The subject matter disclosed herein generally relates to removing an unwanted bird or quantities of birds from an area in a humane way. More particularly, the invention provides a device and method for scaring disruptive birds away from a particular area.

### BACKGROUND

Regions all over the world are being invaded by unwanted flocks of birds, either on a seasonal or a year-round basis. These flocks cover a wide variety of fowls, from small songbirds such as swallows and robins, up to crows and Canadian geese.

The numerous problems these birds can cause for mankind have been well documented. They are known to eat seeds necessary for agricultural planting, destroy growing crops, and eat fruits and vegetables before harvesting. Loud or noisy species can be an annoyance both independently and in large groups. Bird droppings can be even more of a nuisance, especially when found in parks, golf courses, beaches, or other recreational areas; or on cars, boats, or other expensive devices. Even urban areas suffer from large bird populations, with many municipalities implementing various measures to try to disperse the large flocks living in their neighborhoods.

Further, with the advanced technology of the human race, the presence of birds in certain locations poses a hazard to human lives, expensive equipment, and to the birds themselves. For example, there are many reports of airplane accidents during takeoff and landing caused by bird strikes. Additionally new threats to birds have been created with the growing emphasis on alternative energy such as wind and solar. There are many worries that wind turbines and solar concentrating arrays have claimed many avian lives over the past few years.

Thus, an effective and reliable way to frighten birds away from a location would be well received in the art.

### BRIEF DESCRIPTION

According to one aspect of the invention, a device for scaring birds comprises a powered flying device and a predator device attached to the powered flying device.

According to a second aspect of the invention, a method for scaring birds comprises providing a powered flying device, attaching a predator device to the powered flying device, and flying the powered flying device and attached predator device in an area where birds may be present.

According to a third aspect of the invention, a bird scaring device comprises a raptor silhouette and a powered flying device, wherein the raptor silhouette is suspended from the powered flying device.

### BRIEF DESCRIPTION OF THE DRAWINGS

The subject matter which is regarded as the invention is particularly pointed out and distinctly claimed in the claims included at the conclusion of this specification. The foregoing and other features and advantages of the invention are apparent from the following detailed description taken in conjunction with the accompanying drawings in which:

FIG. 1 depicts a perspective view of a bird scaring device including a powered flying device and an attached predator device in accordance with one embodiment;

FIG. 2 depicts a perspective view of the powered flying device of FIG. 1 in accordance with one embodiment;

FIG. 3a depicts a bottom view of the bird scaring device of FIG. 1 in accordance with one embodiment;

FIG. 3b depicts a bottom view of a second bird scaring device in accordance with one embodiment;

FIG. 3c depicts a bottom view of a third bird scaring device in accordance with one embodiment; and

FIG. 4 depicts the bird scaring device of FIG. 1 in use in accordance with one embodiment.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the devices thereof, the relative arrangement thereof, etc; these are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

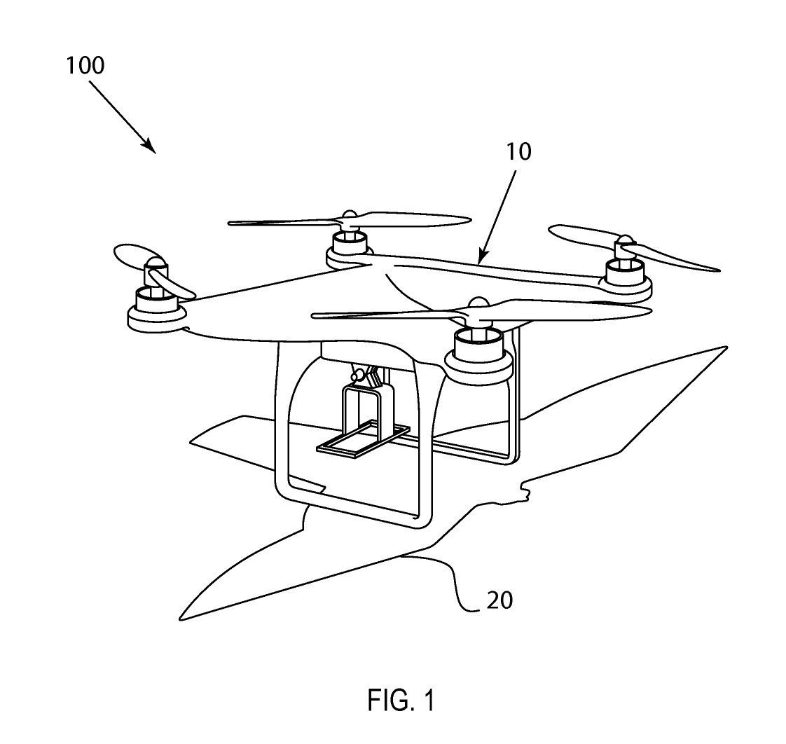

Referring now to FIG. 1, there is shown one embodiment of the bird scaring device 100, comprised of a powered flying device 10 and a predator device 20. The bird scaring device 100 utilizes birds' or other prey's natural fear of the predator resembled by the predator device 20 to frighten such prey away. The device may be used to scare birds from a specific area as needed for special events or occasions, or may be used more routinely to establish a long term bird-free area. As further described below, various types of powered flying devices 10 are contemplated, and the predator device 20 may be of any bird or predator suitable to frighten the unwanted bird or prey population.

The powered flying device 10 enhances the utility of the predator device 20 by enabling presentation of the predator device 20 from a variable height. The present invention allows the image to be freely moveable, a feature which will enhance both convenience of use and the frightening nature desired to be achieved. Further, the variable positioning offered by the powered flying device 10 affords the opportunity to place the predator device 20 in the most realistic, and simultaneously most frightening position, for other birds and prey—overhead. The bird scaring device 100, by utilizing a powered flying device 10 to mobilize the predator device 20, allows the device to be placed above an unwanted bird, animal, or other pest, thus maximizing the threat to the target animal.

In addition to providing for ideal placement of the predator device 20, the current invention's inherent mobility provides for advanced frightening tactics. Instead of simply hovering, gliding, or flying overhead or around a specific area, the bird scaring device 100 may be used to actively threaten individual birds or groups of birds. For example, by remotely controlling the powered flight device 10, a user may move the predator device 20 in a threatening manner toward a bird or group of birds. This movement may be in the form of a sudden descent from above, thus mimicking a diving or attacking bird of prey; or it may be by simply circling overhead, mimicking a bird of prey scoping out its territory for its next meal. Many differing movements are contemplated that would approximate the real life movements of a raptor/bird of prey or other predator. These movements may be altered depending on the specific predator device 20 used, or varied based upon the time of day, season, weather, geographical location, or other factors.

To facilitate successful frightening, the bird scaring device 100 may be provided with multiple predator devices 20, each of which may work more successfully for specific target prey. These predator shapes 20 may be easily replaced or switched to ensure a broad utility against a variety of pests and longevity of the device. A further description of the various embodiments of the predator device 20 is included below; however, the predator may be of any shape or design suitable to frighten birds.

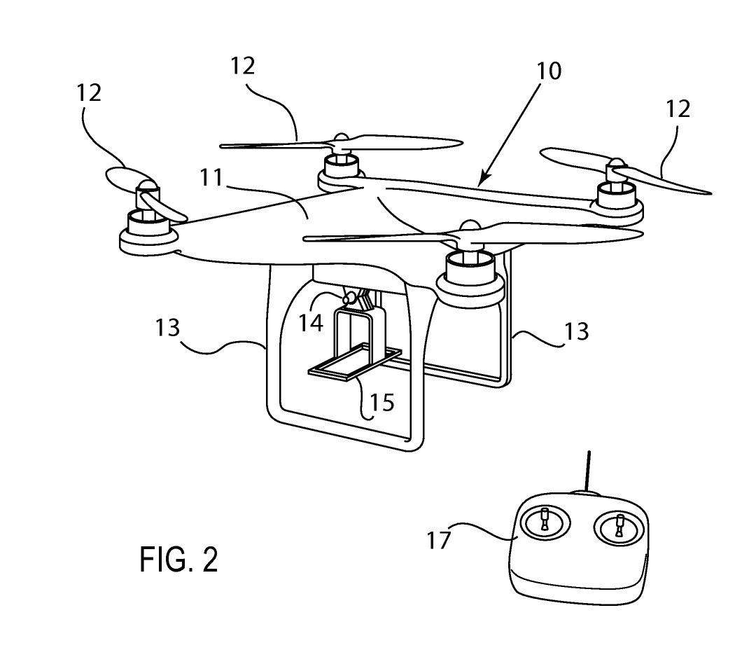

Referring to FIG. 2, there is shown a more detailed view of one embodiment of the powered flying device 10. In this embodiment the powered flying device 10 comprises a hovering device or quadcopter/quadrotor, commonly referred to as a drone. Any suitable device capable of powered or controlled flight may be used for the powered flying device 10. By way of example only, additional options may include powered airplanes, helicopters, other hovering devices, gliders, blimps, etc. In one embodiment the powered flying device 10 is remotely controlled from a controller 17. The controller 17 may comprise a standard radio remote control; an iPhone, iPad, smartphone, or other electronic device; or other similar devices. The communication between the powered flying device 10 and the controller 17 may be via a wired connection, radio waves, Bluetooth, other wireless means, or a combination thereof.

The powered flying device 10 may include a frame 11, attached to one or more rotors 12 which provide lift. The rotors may be powered by one or more electric motors (not shown) or by other means. Other means of providing lift may be used, as known in the art. The powered flying device 10 may also include landing gear or supports 13. The powered flying device 10 may also have one or more attachment points 14 connected to the frame 11 or landing gear 13. The attachment point 14 may serve to allow for the connection of an accessory mount 15. Alternatively, only the attachment point 14 may be provided, enabling the user to choose which objects they would like to attach. Either the attachment point 14 or the accessory mount 15 may support additional features of the powered flying device 10, such as the predator device 20, a camera, a video camera, or other device.

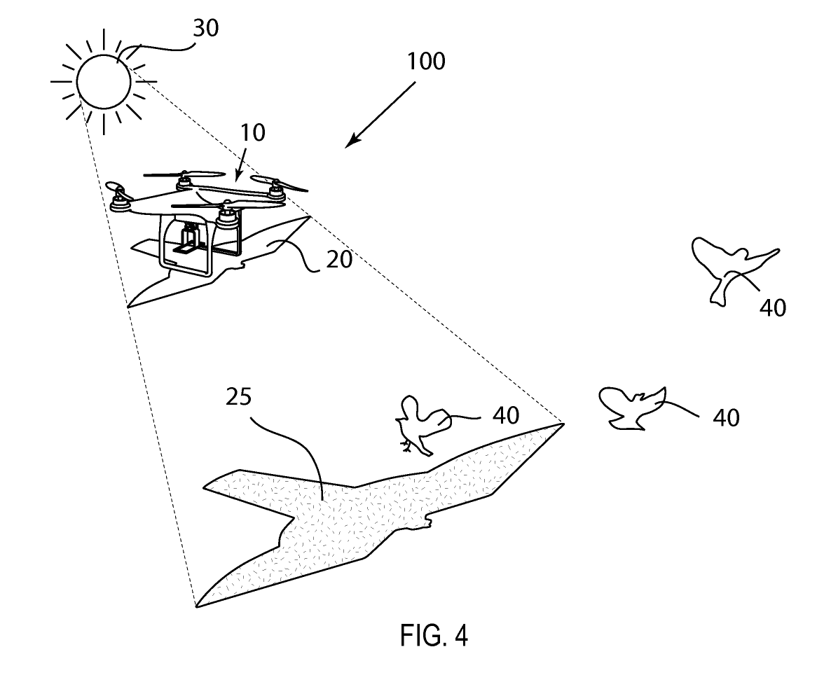

Referring now to FIGS. 1 and 4 in conjunction with FIG. 2, in one embodiment of the invention, the predator device 20 may be attached to either the attachment point 14 or the accessory mount 15. Alternatively, the predator device 20 may be attached to the frame 11, landing gear or supports 13, or other suitable portion of the powered flying device 10. Various means of attachment may be used, regardless of the chosen attachment location. For example, the predator device 20 may be attached directly to the attachment point 14, accessory mount 15, frame 11, landing gear or supports 13, or other suitable location on the powered flying device 10. Alternatively, the predator device 20 may be attached to the powered flying device 10 by a rod or other rigid support. In still further embodiments, a more flexible means of attachment may be used such as a cable, cord, line, or similar device.

The predator device 20 may be located in any position relative to the powered flying device 10. As shown in FIG. 1, in a first embodiment, the predator shape 20 is located below the powered flying device 10. In other embodiments, the predator device 20 may be attached to the side of the powered flying device 10 or even mounted above the powered flying device 10. Further, multiple predator devices 20 may be attached to various points of the powered flying device 10, and in varying relative positions.

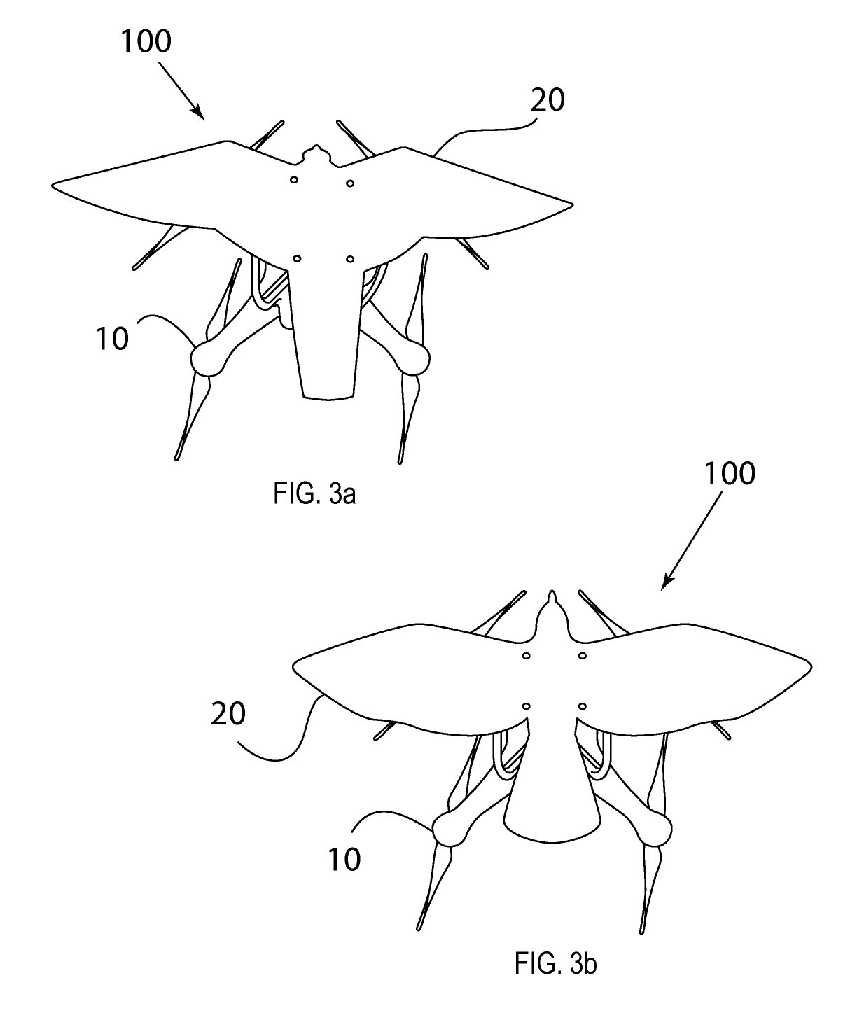

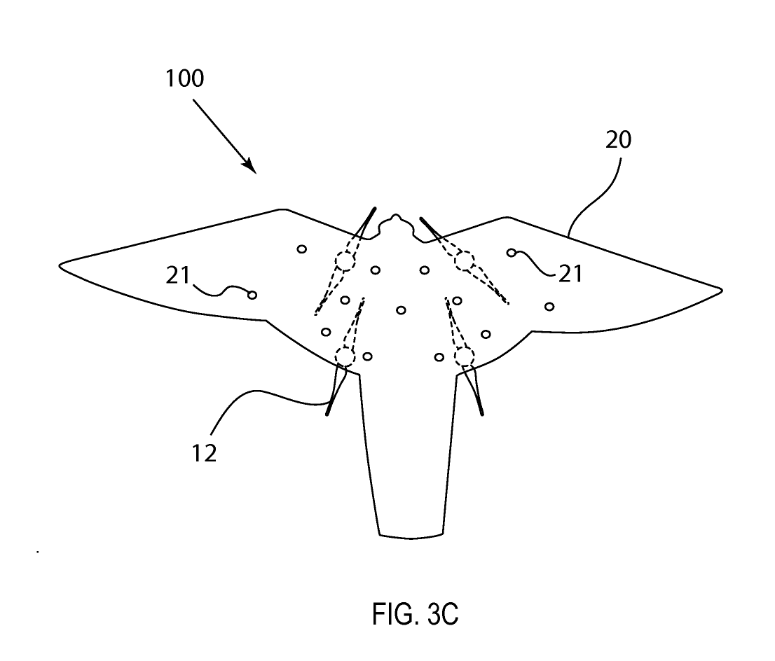

Referring again to the embodiment depicted in FIGS. 1, 3a, 3b, and 3c in which the predator shape 20 is located below the powered flying device 10, the predator device 20 may still be attached in varying positions. For example, the predator device 20 may be attached such that it is located substantially in front of, behind, or to the side of, the powered flying device. Such positioning may enhance the lifelike representation of the predator device 20 in flight or may provide benefit regarding lift, weight distribution, or other aerodynamic concerns. Alternative positions may also serve to enable the projection of a clear silhouette by the predator device 20, the silhouette being thus separated from that of the powered flying device 10. Further, in an embodiment where a flexible attachment means is used, the predator device 20 may move among these different positions freely.

The predator device 20 may be positioned at any distance from the powered flying device 10. For example, depending on the type of powered flying device 10 used, the predator device 20 may be located substantially close to the powered flying device to minimize drag and increase maneuverability, or may be located farther away to avoid impact on the lift generated by the rotors 12 and improve the frightening characteristics.

Regarding control of the powered flying device 10's flight, there are many methods well-known in the art which may be suitable for the bird scaring device 100. For example, the flight may be automated, such as by following a preset route according to GPS landmarks. In other embodiments, a user may control the flight using the controller 17. The user may control the flight based upon a substantially real-time image from an attached camera, or may control the flight based upon the user's own line of sight. Further, any other methods of guiding the powered flying device 10's flight may be used.

With reference now to FIG. 3a, a detailed view of one embodiment of the bird scaring device 100 is shown from a bottom view in order to more fully show the predator device 20. Viewing this embodiment from this perspective the predator shape 20 is clearly visible; however, portions of the powered flying device 10 may or may not be visible, depending on the specific embodiment being used and the angle of the viewer. In the embodiment shown, the predator device 20 resembles the shape of a bird of prey, more specifically that of an accipiter, falcon, or kite as seen overhead. As will be apparent to one having skill in the art, the predator device 20 may comprise any predator, with variations chosen based upon geographical location, the type of bird or prey targeted for removal, the season or weather, or other factors. In one embodiment, the most effective predator device 20 may be a raptor or bird of prey. By way of example only, and without limitation, other possible options for the predator device 20 include, generally, birds from the following families: accipiters, buteos, eagles, falcons, harriers, hawks, kites, osprey, owls, and vultures; and more specifically: red-tailed hawk, red-shouldered hawks, Swainson's hawks, broad-winged hawks, short-tailed hawks, rough-legged hawks, ferruginous hawks, northern harriers, northern goshawks, sharp-shinned hawks, Cooper's hawks, gyrfalcons, peregrine falcons, American kestrels, merlins, prairie falcons, swallow-tailed kites, white-tailed kites, Mississippi kites, golden eagles, bald eagles, turkey vultures, condors, etc. The predator device 20 may be of any size or device suitable for attachment to the powered flying device 10. While a wide range of sizes and devices are thus available for the predator device 20, improved results may be obtained when the overall shape, size, and overall look and feel are substantially similar to the real life proportions of the predator meant to be resembled.

Referring to FIG. 3b, a detailed view of one embodiment of the bird scaring device 100 is shown from a bottom view to enable visualization of the predator device 20. Viewing this embodiment from this perspective, the predator shape 20 is clearly visible, however, portions of the powered flying device 10 may or may not be visible, depending on the specific embodiment being used and the angle of the viewer. In the embodiment shown, the predator device 20 is of a shape approximating that of a buteo, harrier, or hawk as it would appear while flying overhead.

Referring now to FIG. 3c, a bottom view of one embodiment of the bird scaring device 100 is shown. In this embodiment, the predator shape 20 is substantially larger than the powered flying machine 10. While small portions of the powered flying device 10 may be seen (here the tips of the rotors 12) embodiments where no portion of the powered flying machine 10 are visible from below are contemplated.

Further, the predator device 20 may be made of any suitable material or combination of materials, such as plastics, woods, metals, composites, or other materials. A durable but lightweight material may be used in order to minimize weight. The predator device 20 may be predominantly co-planar to minimize weight and/or drag while retaining the functional shape, outline, or image as seen from below. Alternatively, a more varied and three-dimensional device may be used to enhance the natural appearance and/or frightening nature, or to impact the aerodynamics of the bird scaring device 100. In embodiments of the predator device 20 that are not predominantly co-planar the predator device 20 may be substantially hollow to reduce weight. Alternative methods of reducing weight may be used as well, such as using cross-supports in an otherwise hollow device.

The predator device 20 may be of any size suitable. For example the predator device 20 may be smaller than the powered flying device 10 in order to facilitate maneuverability and flight capabilities. Alternatively, a larger predator device 20 may be used, to project a more dangerous predator.

Given the various sizes of the predator device 20 and the powered flying device 10, as well as the various relative positions contemplated, the predator device 20 may have many different effects on the aerodynamic qualities of the powered flying device 10 and the bird scaring device 100. These effects may be utilized or mitigated in various ways. For example, the predator device 20 may be curved or otherwise shaped in order to increase laminar flow or other aerodynamic qualities. When the predator device 20 chosen has an outline or profile smaller than that of the powered flying device, the rotors 12 may be located outside or partially outside of the silhouette or outline of the predator device and thus will not experience any interference from the predator device. However, if a larger predator device 20 is used, the rotors 12 may be located over or partially over the silhouette or outline of the predator device 20. In this embodiment, the predator shape 20 may be provided with vents or holes 21 in order to allow the passage of air and facilitate the lift generated by the rotors 12. Other design features known in the art to facilitate lift and aerodynamic qualities may also be included. Further, while these features may be holes or openings in the material of the predator device 20, they could also be areas of differing fabrics or material, such as a mesh or breathable portion. Further, these may be disposed as necessary on the predator device 20, and no attempt to limit the placement, orientation, or pattern of these features is intended, whether in relation to each other or to the overall design.

Referring now to FIG. 4, there is shown the bird scaring device of FIG. 1 in use in accordance with one embodiment. This embodiment of the bird scaring device 100, with a quadcopter embodiment of the powered flying device 10, and a predator device 20, is depicted in flight over a target area. The predator device 20 may cast a predator device shadow 25 based upon its interference with the sun's 30 rays. Alternatively, even if the sun 30 or other light source is not bright enough or in an ideal position for the predator shape 20 to cast a distinguishable predator shape shadow 25, any animal or bird 40 located below the predator shape 20 would see the predator shape 20 upon looking up. Thus, the bird 40 or other pest would discern the presence of the predator shape 20—either through direct visualization of the predator shape 20 or visualization of the predator shape shadow 25 cast by the predator shape 20—and be frightened away.

In addition to the visual likeness of a predator, a sound emitting device such as a speaker, receiver/transmitter, and/or a recorder may also be attached to the bird scaring device 100. The sound emitting device may be used to emit the sound of a bird of prey such as a hawk, falcon, eagle, etc. Other noises may also be emitted as desired. The sound or noise may be emitted randomly, at set intervals, or timed with specific actions, such as circling, gliding, diving, attacking, etc., in order to mimic a live predator or otherwise maximize the frightening effect on the prey.

What is claimed is:

1. A device for scaring birds, comprising:
a powered flying device; and
a predator device attached to the powered flying device.

2. The device of claim 1, wherein the predator device is in the shape of a raptor or bird of prey.

3. The device of claim 1, wherein the predator device is a substantially co-planar silhouette outline of a bird of prey.

4. The device of claim 1, wherein the powered flying device is remote-controllable.

5. The device of claim 1, wherein the powered flying device is a quadcopter.

6. The device of claim 1, wherein the predator device is suspended below the powered flying device.

7. The device of claim 1, further comprising:
a sound emitting device.

8. A method for scaring birds, comprising:
providing a powered flying device;
attaching a predator device to the powered flying device; and
flying the powered flying device and attached predator device in an area where birds may be present.

9. The device of claim 8, wherein the predator device is in the shape of a raptor or bird of prey.

10. The device of claim 8, wherein the predator device is a substantially co-planar silhouette outline of a bird of prey.

11. The method of claim 8, wherein the powered flying device is remote-controllable.

12. The method of claim 8, wherein the powered flying device is a quadcopter.

13. The method of claim 8, wherein the predator device hangs below the powered flying device.

14. The method of claim 8, further comprising:
attaching a sound emitting device to the powered flying device or the attached predator device; and
emitting a sound from the sound emitting device.

15. The method of claim 8, wherein the flying the powered flying device in an area where birds may be present is characterized by:
flying the powered flying device such that the predator device moves in a way which substantially approximates the hovering or gliding of a bird of prey.

16. The method of claim 8, wherein the flying the powered flying device in an area where birds may be present is characterized by:
flying the powered flying device such that the predator device is moved toward a target animal in a manner substantially approximating the attack of a bird of prey.

17. A bird scaring device, comprising:
a raptor silhouette; and
a powered flying device;
wherein the raptor silhouette is suspended from the powered flying device.

18. The device of claim 17, wherein the raptor silhouette is a substantially co-planar.

19. The device of claim 17, wherein the powered flying device is remote-controllable.

20. The device of claim 17, further comprising:
a sound emitting device attached to the raptor silhouette or the powered flying device.
